(19) United States
(12) Patent Application Publication
(10) Pub. No.: US 2026/0050362 A1
(43) Pub. Date: Feb. 19, 2026

(54) METHOD FOR PROJECT MANAGEMENT, ELECTRONIC DEVICE, AND MEDIUM

(71) Applicant: Beijing Zitiao Network Technology Co., Ltd., Beijing (CN)

(72) Inventors: Linxuan SHI, Beijing (CN); Dongyang ZHAO, Beijing (CN)

(21) Appl. No.: 19/301,095

(22) Filed: Aug. 15, 2025

(30) Foreign Application Priority Data
Aug. 16, 2024 (CN) 202411132080.6

(51) Int. Cl. G06F 3/0483; G06Q 10/0631

(52) U.S. Cl. CPC G06F 3/0483; G06Q 10/06315

(57) ABSTRACT

Embodiments of the present disclosure disclose a method for project management, an electronic device, and a computer-readable medium. And the method includes: displaying, in a tree view, a sub-item creation control for a first item, where the tree view presents a work item in a hierarchical structure, and the first item is a work item in the tree view; displaying a sub-item creation interface based on a first trigger operation on the sub-item creation control; creating a second item based on input information in the sub-item creation interface, where the second item is a child work item of the first item; and displaying, in the tree view, second item information of the second item.

### CROSS-REFERENCE TO RELATED APPLICATION

The present application claims priority to Chinese Patent Application No. 202411132080.6, filed on Aug. 16, 2024, which is incorporated herein by reference in its entirety as a part of the present application.

### TECHNICAL FIELD

The present disclosure relates to a method for project management, an electronic device, and a computer-readable medium.

### BACKGROUND

With the development of computers, users can use electronic devices to implement various functions. For example, users can interact with other users through the electronic device, and can also use the electronic device to promote work.

In some scenarios, a tool or platform (such as a project management system) based on data management can be built to accelerate the project launch and avoid project risks by creating standardized business processes.

### SUMMARY

The Summary is provided to introduce the concepts in a concise form, which will be described in detail in the Detailed Description section below. The Summary is not intended to identify key features or essential features of the claimed technical solution, nor is it intended to be used to limit the scope of the claimed technical solution.

An embodiment of the present disclosure provides a method for project management. The method includes: displaying, in a tree view, a sub-item creation control for a first item, where the tree view presents a work item in a hierarchical structure, and the first item is a work item in the tree view; displaying a sub-item creation interface based on a first trigger operation on the sub-item creation control; creating a second item based on input information in the sub-item creation interface, where the second item is a child work item of the first item; and displaying, in the tree view, second item information of the second item.

An embodiment of the present disclosure provides a project management apparatus. The apparatus includes: a first display unit configured to display, in a tree view, a sub-item creation control for a first item, where the tree view presents a work item in a hierarchical structure, and the first item is a work item in the tree view; a second display unit configured to display a sub-item creation interface based on a first trigger operation on the sub-item creation control; a creation unit configured to create a second item based on input information in the sub-item creation interface, where the second item is a child work item of the first item; and a third display unit configured to display, in the tree view, second item information of the second item.

An embodiment of the present disclosure provides an electronic device. The electronic device includes: one or more processors; and a storage apparatus configured to store one or more programs, where the one or more programs, when executed by the one or more processors, cause the one or more processors to perform the method for project management according to any one of the present disclosure.

An embodiment of the present disclosure provides a computer-readable medium storing a computer program which, when executed by a processor, performs the method for project management according to any one of the present disclosure.

### BRIEF DESCRIPTION OF DRAWINGS

The above and other features, advantages and aspects of the embodiments of the present disclosure will become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale.

FIG. 1 is a flowchart of an embodiment of a method for project management according to the present disclosure;

FIGS. 2A, 2B and 2C are schematic diagrams of application scenarios of the method for project management according to the present disclosure;

FIGS. 3A and 3B are schematic diagrams of an application scenario of the method for project management according to the present disclosure;

FIG. 4 is a schematic diagram of an application scenario of the method for project management according to the present disclosure;

FIG. 5 is a schematic structural diagram of an embodiment of a project management apparatus according to the present disclosure;

FIG. 6 is an exemplary system architecture in which the method for project management according to an embodiment of the present disclosure can be applied; and

FIG. 7 is a schematic diagram of a basic structure of an electronic device provided according to an embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms, and should not be interpreted as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this respect.

As used herein, the term “include/comprise” and its variants are open-ended inclusions, that is, “include/comprise but not limited to”. The term “based on” is “based at least in part on”. The term “one embodiment” means “at least one embodiment”; the term “another embodiment” means “at least one other embodiment”; and the term “some embodiments” means “at least some embodiments”. Related definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifications of “one” and “more” mentioned in the present disclosure are illustrative rather than restrictive, and those skilled in the art should understand that unless the context clearly indicates otherwise, it should be understood as “one or more”.

The names of messages or information exchanged between multiple apparatuses in the implementations of the present disclosure are only for illustrative purposes, and are not intended to limit the scope of these messages or information.

In one or more embodiments of the present disclosure, the tree view supports direct disassembly of sub-work items and tasks, and the system will quickly complete the pre-filling of relationships and associated field values according to the parent-level instance information during the disassembly.

In one or more embodiments of the present disclosure, when browsing the tree view, the user can click and call up a sub-instance creation pop-up/task creation row next to the parent instance name.

In one or more embodiments of the present disclosure, for the sub-instance creation pop-up, the system will pre-fill the relationships and associated field values according to the parent-child level instance information, and the user can further fill in other information on this basis and complete the creation.

In one or more embodiments of the present disclosure, for the task creation row, the user can continuously create sub-tasks after entering a task name and pressing Enter.

It should be noted that the quick disassembly of instances based on a visual tree hierarchical structure is one of the core operation requirements of the user in the process of browsing the tree view, and the ability to conveniently disassemble sub-items on the view can greatly improve the operation and browsing efficiency of the user in the tree transaction management scenario.

Here, for ease of explanation, some concepts that may be involved in the present disclosure will be introduced first.

Project management system: a software system used to help the project team plan, organize, execute and monitor the project process.

Space (Space), a basic unit for organization and cooperation, can be the management of a single project or the collection of multiple projects.

Work item (Item), a work item for team collaboration, or a collection of items disassembled by the project. Work items can be divided into different types according to different contents, such as requirements, bugs, versions, iterations, milestones, deliverables, etc.

Requirement (Feature) may refer to the software function required by the user to solve a certain problem/achieve a certain goal, which can help team members track specific details.

Bug (Issue) refers to a business requirement that does not conform to the initial definition. For example, a pop-up window is not displayed.

View (View) is a fixed collection of work item query dimensions that are highly concerned within the team. The view can have multiple types, such as a table, a list, a kanban, a gantt chart, and a metric. The table can be an arrangement and combination of field information, and the data is arranged in a cell mode. The gantt chart can show the project progress in a time dimension by a bar chart. The metric is a continuous quantitative process of data definition, collection, and analysis for the software development project, process, and product. For example, requirement throughput, quality, cycle, manpower estimation, etc.

Role (Role), various roles involved in the project, a project requires the cooperation and support of different roles.

WBS (Work Breakdown Structure) schedule, that is, a work breakdown structure schedule, can also be called a WBS schedule, or simply referred to as a schedule.

Process, the basic steps in the life cycle of a matter, which are composed of process nodes and execution modes in an orderly manner. The node can refer to the stage division point of the process.

The node owner, the person responsible for the node task, may be the handler of the node task, or may not be the handler of the node task.

The node participant, the handler of the node task, but not the person in charge of the node task.

The sub-process node is a process subdivision field or a task package under a large-scale plan process, and other processes introduced in a process are called sub-processes in the current process. Other nodes can be disassembled under the sub-process node.

Please refer to FIG. 1, which shows a flowchart of an embodiment of a method for project management according to the present disclosure. This embodiment can be applied to a project management system. As shown in FIG. 1, the method for project management includes the following steps.

Step 101: displaying, in a tree view, a sub-item creation control for a first item.

Step 102: displaying a sub-item creation interface based on a first trigger operation on the sub-item creation control.

Step 103: creating a second item based on input information in the sub-item creation interface.

Step 104: displaying, in the tree view, second item information of the second item.

Here, the tree view presents a work item in a hierarchical structure.

Here, the first item is a work item in the tree view. It can be understood that the second item is also a work item in the tree view.

Here, the second item is a child work item of the first item, that is, a sub-item or an indirect sub-item.

The sub-item creation control is used to quickly disassemble the work item in the scenario of the tree view. The form of the sub-item creation control can be, for example, a button with the word “create” or a “+” button.

Optionally, the display positions of the tree view may include but not be limited to at least one selected from the group consisting of: a tree mode (including a tree gantt chart) of a single work item/panoramic view; a tree mode (including a tree gantt chart) of a single work item/panoramic view inserted on a workbench/space homepage; and a tree mode (including a tree gantt chart) of an associated view generated by a view control on a details page, including a small window state and a full screen state of the details page.

The form of the first trigger operation can be set according to actual application scenarios, such as a click.

The sub-item creation interface is used to fill in information of the sub-item. The input information of the sub-item creation interface can be manually input or automatically pre-filled by the electronic device.

As an example, the sub-item creation control may include a confirmation control, and the second item can be created based on the input information by triggering the confirmation control.

It should be noted that, in the project management manner provided in this embodiment, the sub-item creation control can be displayed for the first item in the tree view, where the tree view presents the work item in the hierarchical structure, and the first item is the work item in the tree view; the sub-item creation interface is displayed based on the first trigger operation on the sub-item creation control; the second item is created based on the input information in the sub-item creation interface, where the second item is the child work item of the first item; and the second item information of the second item is displayed in the tree view. Therefore, the sub-item can be conveniently disassembled on the tree view, which can greatly improve the operation and browsing efficiency of the user in the tree transaction management scenario.

As an example, with the above project management manner, in the iteration management scenario, the requirements that need to be promoted under each iteration can be quickly disassembled on the iteration view based on different iteration targets; that is, the iteration view is opened; a sub-item creation button (such as “+”) is clicked next to the iteration name to call up a requirement creation pop-up window; the field information is filled in the creation pop-up window; and the confirmation creation is clicked. The scenarios such as version management/requirement management/project management/goal management are similar.

As an example, with the above project management manner, sub-requirements and tasks are disassembled by operating in an associated requirement view control on a project details page. That is, the project details page is opened; a sub-item creation button is clicked on a requirement name row in an associated view region; a requirement/task work item type is selected to call up a requirement creation pop-up window; the field information is filled in the creation pop-up window; and the confirmation creation is clicked.

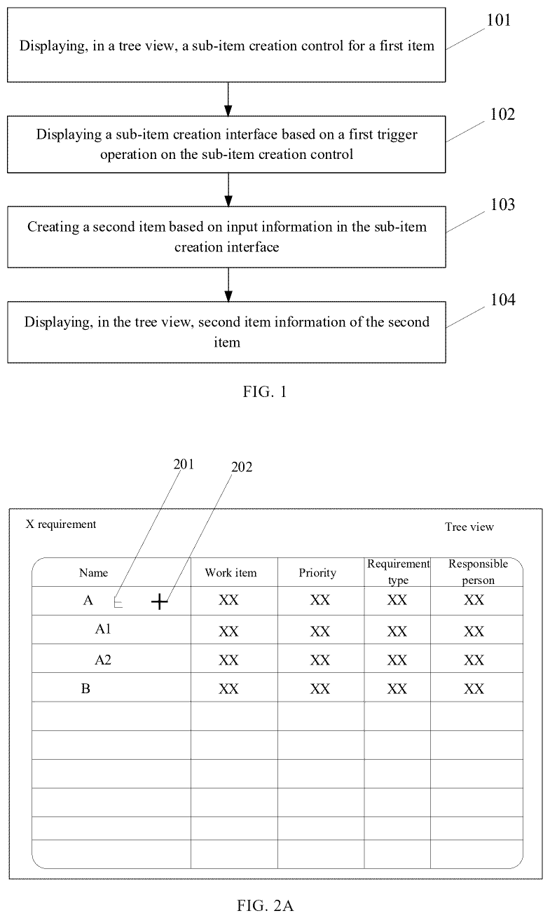

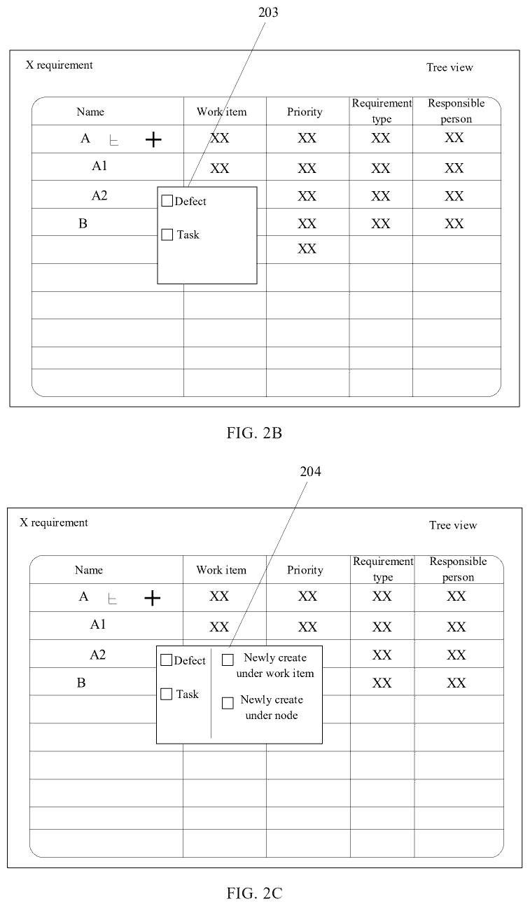

As an example, please refer to FIG. 2A, which shows a hierarchy indicator 201 and a sub-item creation control 202 in a tree view, and the hierarchy indicator 201 indicates that the work item has a sub-item.

In some embodiments, the displaying the sub-item creation interface based on the first trigger operation on the sub-item creation control includes: determining a sub-item type based on an optional sub-item type of the first item in response to the first trigger operation on the sub-item creation control; and displaying, in the sub-item creation interface, a preset field corresponding to the sub-item type according to the determined sub-item type.

The optional sub-item type of the first item can be determined according to the type of the first item. As an example, the type of the first item is iteration, and the optional sub-item type of the first item may include at least one selected from the group consisting of: requirements and bugs.

Optionally, in the project management space, when the parent item is of the A type, the optional sub-item type of the sub-item may include a specific type.

As an example, please refer to FIG. 2B and FIG. 2C, FIG. 2B shows a first type menu 203, and the first type menu can display optional types of multiple sub-items. FIG. 2B shows a second type menu 204, and the second type menu 204 shows not only the optional types of the sub-item, but also candidate creation manners of the sub-item, for example, creation under the work item or creation under the node, and the candidate creation manner is used to determine a parent item of the sub-item.

Here, the corresponding information between the work item types and the fields may be stored in advance. For example, the fields corresponding to the requirement type may include at least one selected from the group consisting of: a requirement name, a priority, and an associated work item. For example, the fields corresponding to the bug type may include at least one selected from the group consisting of: a bug name, a priority, a discovery stage, a bug type, and an associated work item.

In some embodiments, the determining the sub-item type based on the optional sub-item type of the first item includes: displaying multiple optional sub-item types when a number of optional sub-item types of the first item is more than one, determining the sub-item type according to a selection operation on the displayed optional sub-item types; and determining the optional sub-item type of the first item as the sub-item type when a number of optional sub-item type of the first item is one.

As an example, when the optional type of the sub-item of the first item includes requirements, the requirements can be used as the type of the sub-item.

As an example, when the optional types of the sub-item of the first item include requirements and bugs, the requirements and the bugs can be displayed, and when the user selects the requirements, the requirements can be used as the type of the sub-item.

Therefore, the sub-item type can be determined according to the optional sub-item type of the first item, and then the corresponding sub-item creation interface can be determined, that is, the content in the interface corresponds to the sub-item type. Therefore, the flexibility of creating the sub-item type can be improved, and the corresponding sub-item creation interface can be adaptively displayed according to the sub-item type, so as to improve the speed and accuracy of creating the sub-item.

In some embodiments, the method further includes: pre-filling information of a part of fields in the sub-item creation interface according to first item information.

Here, the pre-filling can be automatically filled in by the electronic device, and the information automatically appears in the field creation interface when the sub-item creation interface is displayed, without the need for the user to fill in.

Optionally, the fields with the pre-filling capability can be preset.

According to different fields, the pre-filled information may or may not be allowed to be modified.

Therefore, the step of the user filling in part of fields is saved, and the speed and information accuracy of creating the sub-item are improved.

In some embodiments, the part of fields include at least one selected from the group consisting of: an associated work item field and a priority.

Therefore, according to the pre-filling of the associated field values based on the parent-child level instance information, the accuracy of the associated work item field values is improved compared with manual judgment.

In some embodiments, the method further includes: determining whether the first item has a child node based on the first trigger operation on the sub-item creation control; displaying a candidate parent item in response to the first item having the child node, where the candidate parent item includes at least one selected from the group consisting of: a child node of the first item and the first item; and determining a parent item of the second item according to a selected candidate parent item, where the parent item of the second item is the child node of the first item or the first item.

Here, the work item may include a sub-work item; the work item may also be identified by a process, and accordingly, the work item may include a child node.

When a sub-item is created under the work item, it can be selected to be directly linked to the work item (that is, directly created) or to be linked to a child node of the work item.

Therefore, the level of the newly created sub-item can be flexibly selected, so that the position of the newly created sub-item in the work item is more accurate, improving management efficiency.

In some embodiments, the step 101 may include: in the tree view, displaying the sub-item creation control for the first item by default in response to the first item already having a sub-item; and in the tree view, displaying the sub-item creation control for the first item based on a second trigger operation on the first item in response to the first item not having a sub-item and in response to the first item having an authority to add a sub-item.

Here, the authority to add a sub-item may indicate that the first item has the ability to add a sub-item. The authority to add a sub-item may be set on the project management side.

The first item already has a sub-item, indicating that the first item has the ability to add a sub-item; the probability of establishing a sub-item again by the parent item having the sub-item is high, and in the case that the first item already has a sub-item, the sub-item creation control is permanently displayed; thus, the operation steps when the user needs to create the sub-item can be reduced, and the efficiency of creating the sub-item can be improved.

That is, in the work item in the tree view, when there is a sub-item, the sub-item creation control is displayed; when there is no sub-item, the sub-item creation control is displayed in response to the trigger operation on the first item. In this implementation, on the one hand, the sub-item creation control can be displayed for the work item with a high probability of establishing a sub-item, so as to minimize the operation steps for the user to create the sub-item; on the other hand, the sub-item creation control may not be displayed for the work item with a low probability of establishing a sub-item, ensuring a concise interface of the tree view.

In some embodiments, the step 101 may include: in the tree view, displaying the sub-item creation control for the first item based on a second trigger operation on the first item.

Here, in the tree view, the sub-item creation control may not be displayed first, to ensure a concise interface of the tree view.

In some embodiments, the step 101 may include: in the tree view, displaying the sub-item creation control for the first item by default.

Here, in the tree view, the sub-item creation control can be permanently displayed by default, so that the operation steps when the user needs to create the sub-item can be reduced, and the efficiency of creating the sub-item can be improved.

In some embodiments, the step 102 may include: determining a sub-item creation interface in a corresponding display form according to a hierarchy corresponding to the sub-item type.

Here, items in the project management system may have a hierarchy. An item at the lowest level (such as a task) does not have the authority to create a sub-item again.

Optionally, the hierarchy type of the first item, which is reduced by one level, can be used as a sub-hierarchy type.

The display forms of the sub-item creation interfaces corresponding to different hierarchy types can be different. For example, the sub-item creation interface corresponding to a sub-item with a high hierarchy may have more content, while the sub-item creation interface corresponding to a sub-item with a low hierarchy may have less content.

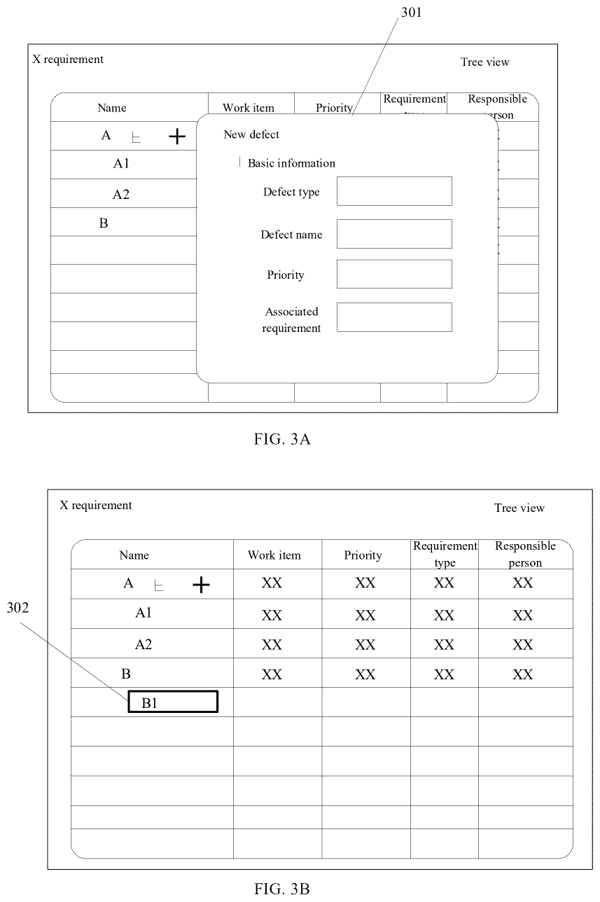

As an example, please refer to FIG. 3A and FIG. 3B. FIG. 3A shows a sub-item details page 301, and FIG. 3B shows a sub-item creation row 302.

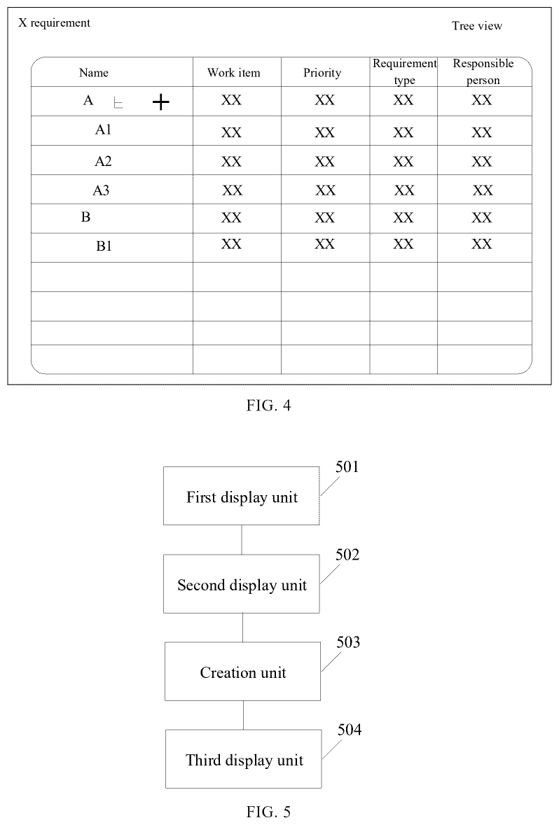

As an example, please refer to FIG. 4, which shows the creation of a sub-item A3 and a sub-item B1 (relative to the tree view shown in FIG. 2) based on the sub-item creation control.

Therefore, different sub-item creation interfaces can be displayed according to the hierarchy type of the sub-item, so as to improve the adaptability of the interface to the amount of content when creating the sub-item, and improve the speed of creating the sub-item.

In some embodiments, the determining the sub-item creation interface in the corresponding display form according to the hierarchy corresponding to the sub-item type includes at least one selected from the group consisting of: displaying a first sub-item creation row in response to the hierarchy corresponding to the sub-item type being the lowest level, where the first sub-item creation row is a row in the tree view; and displaying a sub-item creation details page in response to the hierarchy corresponding to the sub-item type not being the lowest level.

Here, the preset field in the sub-item creation details page is determined based on the sub-item type.

Optionally, the sub-item creation details page may be an interface independent of the tree view. For example, a pop-up window displayed on an upper layer of the tree view.

Therefore, a lightweight sub-item creation row can be used to quickly create an item at the lowest level with less content; and a details page can be used to create an item with more content in detail. According to the characteristics of items at different levels, the corresponding interface is used to input content, which is convenient for the user to quickly fill in, and improves the speed of creating different sub-items.

In some embodiments, the method further includes: displaying a second sub-item creation row in response to a third trigger operation on the first sub-item creation row, where the second sub-item creation row is used to create a third item, and the third item is a child work item of the first item.

As an example, the above trigger operation may be a line feed operation or an enter operation.

That is, an operation such as enter can be triggered in the sub-item creation row to create a new sub-item creation row, and the enter operation can be continuously triggered to continuously create the lowest-level item (such as a task) for the first item. Therefore, multiple sub-items can be quickly created, and the speed of creating the sub-items is improved.

As an example, the overall path may be as follows.

First, the sub-item creation control (entrance).

The implementation of the present disclosure may provide two types of creation positions: creation under the instance and creation under the node.

Call-up condition: both of the following two conditions need to be satisfied, otherwise this entrance will not be displayed. There is a sub-level work item configuration under the current-level work item/current node, and the current operating user has the creation authority for at least one work item; and the relationship is not in a disabled state.

Call-up position: when the floating operation is on the instance row/current node row of the current-level work item, a sub-item creation button is called up on the right side of the instance/node name.

Second, select a creation object

The work item without authority is directly hidden in the drop-down list, and the work item in the external space is displayed with the name of the external space in the drop-down list and separated by a separator.

First, when there is only one type of sub-work item with authority, for the sub-work item not under the node, a creation pop-up window is called up after the sub-item creation control is clicked; for the sub-work item under the node and the corresponding node exists in the current instance process, a node selection panel is called up after the sub-item creation control is clicked, including two creation manners: direct creation and creation under the node, where the creation under the node will further display the options of the current instance nodes available for creation, the order of the options is arranged according to the process topology order of the current instance template nodes, and a creation pop-up window is called up after the selection.

Second, when there are more than one type of sub-work item with authority, a work item selection menu is called up after the sub-item creation control is clicked, and the display order of the options is consistent with the order in the hierarchy configuration. When it is a sub-work item not under the node, a creation pop-up window is called up after “+” is clicked; when it is a sub-work item under the node and the corresponding node exists in the current instance process, a secondary node selection panel is called up after it is selected, including two creation manners: direct creation and creation under the node, where the creation under the node will further display the options of the current instance nodes available for creation, the order of the options is arranged according to the process topology order of the current instance template nodes, and a creation pop-up window is called up after the selection.

Third, fill in the creation pop-up window/input the task row name

First, for the sub-work item

The creation pop-up window can be filled in.

System pre-filling value rules, associated work item field: find the associated work item field at one end of the creation object according to the relationship, and if not, this step can be skipped; if yes, regardless of whether the field is valid in the current creation scenario or whether the content of the parent instance to be filled in hits the data visibility range, the field value is pre-filled. For the single-selected associated work item, the entire field no longer supports modification; for the multi-selected associated work item, deleting the instance option is not supported, but adding other instance options is supported. Relationship (not exposed on the front-end interface): pre-fill the association relationship logic between the parent instance and the creation object instance.

Confirm creation. After clicking confirmation creation, the details page of the last created instance is opened. Supporting modification: while opening the instance details page, the view page stays at the browsing position before creation.

Second, for tasks.

At the bottom of the creation target hierarchy, a blank task creation row is called up and automatically activated. When the corresponding row is not in the current page, the page needs to be scrolled until the row just appears.

In the state where the blank row is activated, the sub-item creation control is continuously clicked to keep the activation state of the single blank row unchanged.

After the user inputs a task name and presses Enter, it is verified whether the task is in this position under the existing filter/sort/grouping condition configuration, and if not, the entire row is highlighted to prompt “{work item type} will be moved to a new group when another area is clicked”/“{work item type} will be moved to a new sorting position when another area is clicked”/“{work item type} will be filtered when another area is clicked”, and after the blank area is clicked, the task is moved to the corresponding position, and a new blank row is activated below.

In the state where the blank row is activated, when the user does not input any content, the blank row disappears after the mouse is out of focus.

Further referring to FIG. 5, as an implementation of the methods shown in the above figures, the present disclosure provides an embodiment of a project management apparatus. The apparatus embodiment corresponds to the method embodiment shown in FIG. 1, and the apparatus can be specifically applied to various electronic devices.

As shown in FIG. 5, the project management apparatus in this embodiment includes: a first display unit 501, a second display unit 502, a creation unit 503, and a third display unit 504. The first display unit 501 is configured to display, in a tree view, a sub-item creation control for a first item, where the tree view presents a work item in a hierarchical structure, and the first item is a work item in the tree view; the second display unit 502 is configured to display a sub-item creation interface based on a first trigger operation on the sub-item creation control; the creation unit 503 is configured to create a second item based on input information in the sub-item creation interface, where the second item is a child work item of the first item; and the third display unit 504 is configured to display, in the tree view, second item information of the second item.

In this embodiment, for the specific processing of the first display unit 501, the second display unit 502, the creation unit 503 and the third display unit 504 of the project management apparatus and the technical effects thereof, reference may be made to the related description of steps 101, 102, 103 and 104 in the corresponding embodiment of FIG. 1, respectively, which will not be repeated here.

In some embodiments, the displaying the sub-item creation interface based on the first trigger operation on the sub-item creation control includes: determining a sub-item type based on an optional sub-item type of the first item in response to the first trigger operation on the sub-item creation control; and displaying, in the sub-item creation interface, a preset field corresponding to the sub-item type according to the determined sub-item type, where corresponding information between a type and a field is stored in advance.

In some embodiments, the determining the sub-item type based on the optional sub-item type of the first item includes: displaying multiple optional sub-item types when a number of optional sub-item types of the first item is more than one, determining the sub-item type according to a selection operation on the displayed optional sub-item types; and determining the optional sub-item type of the first item as the sub-item type when a number of optional sub-item type of the first item is one.

In some embodiments, the apparatus is further configured to pre-fill information of part of fields in the sub-item creation interface according to first item information.

In some embodiments, the part of fields include at least one selected from the group consisting of: an associated work item field and a priority.

In some embodiments, the apparatus is further configured to determine whether the first item has a child node based on the first trigger operation on the sub-item creation control; display a candidate parent item in response to the first item having the child node, where the candidate parent item includes at least one selected from the group consisting of: a child node of the first item and the first item; and determine a parent item of the second item according to a selected candidate parent item, where the parent item of the second item is the child node of the first item or the first item.

In some embodiments, the displaying, in the tree view, the sub-item creation control for the first item includes at least one selected from the group consisting of: in the tree view, displaying the sub-item creation control for the first item by default in response to the first item already having a sub-item; in the tree view, displaying the sub-item creation control for the first item based on a second trigger operation on the first item in response to the first item not having a sub-item and in response to the first item having an authority to add a sub-item; in the tree view, displaying the sub-item creation control for the first item based on a second trigger operation on the first item; and in the tree view, displaying the sub-item creation control for the first item by default.

In some embodiments, the displaying the sub-item creation interface based on the first trigger operation on the sub-item creation control includes: determining a sub-item creation interface in a corresponding display form according to a hierarchy corresponding to the sub-item type.

In some embodiments, the determining the sub-item creation interface in the corresponding display form according to the hierarchy corresponding to the sub-item type includes at least one selected from the group consisting of: displaying a first sub-item creation row in response to the hierarchy corresponding to the sub-item type being the lowest level, where the first sub-item creation row is a row in the tree view; and displaying a sub-item creation details page in response to the hierarchy corresponding to the sub-item type not being the lowest level.

In some embodiments, the apparatus is further configured to display a second sub-item creation row in response to a third trigger operation on the first sub-item creation row, where the second sub-item creation row is used to create a third item, and the third item is a child work item of the first item.

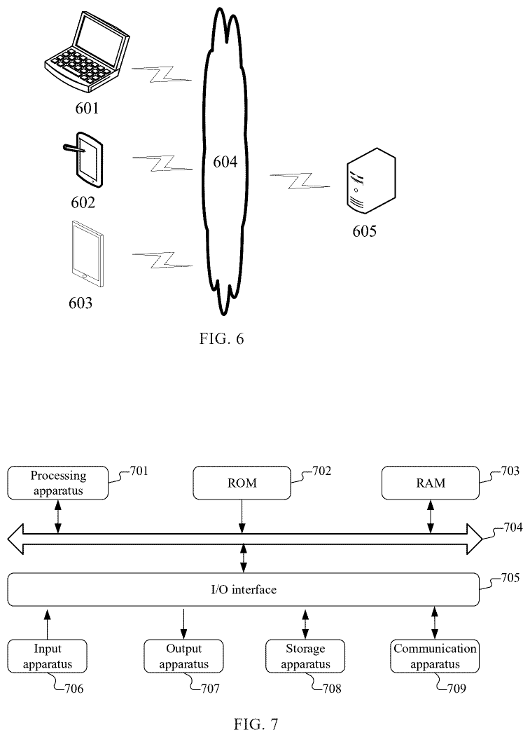

Please refer to FIG. 6, which shows an exemplary system architecture in which the method for project management according to an embodiment of the present disclosure can be applied.

As shown in FIG. 6, the system architecture may include terminal devices 601, 602, 603, a network 604 and a server 605. The network 604 is used as a medium to provide a communication link between the terminal devices 601, 602, 603 and the server 605. The network 604 may include various connection types, such as a wired or wireless communication link or an optical fiber cable.

The terminal devices 601, 602, 603 can interact with the server 605 through the network 604 to receive or send messages or the like. Various client applications can be installed on the terminal devices 601, 602, 603, such as a web browser application, a search application, and a news information application. The client application in the terminal devices 601, 602, 603 can receive instructions from the user and complete corresponding functions according to the instructions of the user, for example, add corresponding information to the information according to the instructions of the user.

The terminal devices 601, 602, 603 may be hardware or software. When the terminal devices 601, 602, 603 are hardware, they may be various electronic devices with a display screen and supporting web browsing, including but not limited to smart phones, tablet computers, e-book readers, MP3 players (Moving Picture Experts Group Audio Layer III, dynamic image expert compression standard audio level 3), MP4 (Moving Picture Experts Group Audio Layer IV, dynamic image expert compression standard audio level 4) players, laptop computers, desktop computers, etc. When the terminal devices 601, 602, 603 are software, they can be installed in the above-mentioned electronic devices. It can be implemented as multiple software or software modules (for example, software or software modules used to provide distributed services), or it can be implemented as a single software or software module. There is no specific limitation here.

The server 605 may be a server that provides various services, such as receiving an information acquisition request sent by the terminal devices 601, 602, 603, and acquiring display information corresponding to the information acquisition request through various methods according to the information acquisition request. The relevant data of the display information is sent to the terminal devices 601, 602, 603.

It should be noted that the method for project management provided in the embodiments of the present disclosure may be executed by the terminal device, and accordingly, the project management apparatus may be provided in the terminal devices 601, 602, 603. In addition, the method for project management provided in the embodiments of the present disclosure may also be executed by the server 605, and accordingly, the project management apparatus may be provided in the server 605.

It should be understood that the number of terminal devices, networks and servers in FIG. 6 is only schematic. According to implementation requirements, any number of terminal devices, networks and servers may be provided.

Reference is made to FIG. 7 below, which shows a schematic structural diagram of an electronic device (such as a terminal device or a server in FIG. 6) suitable for implementing the embodiments of the present disclosure. The terminal device in the embodiments of the present disclosure may include, but is not limited to, mobile terminals such as a mobile phone, a laptop, a digital broadcast receiver, a PDA (Personal Digital Assistant), a PAD (tablet computer), a PMP (Portable Multimedia Player), a vehicle-mounted terminal (such as a vehicle-mounted navigation terminal), and fixed terminals such as a digital TV and a desktop computer. The electronic device shown in FIG. 7 is only an example and should not impose any restrictions on the functions and scope of use of the embodiments of the present disclosure.

As shown in FIG. 7, the electronic device may include a processing apparatus (such as a central processing unit and a graphics processing unit) 701, which can perform various appropriate actions and processing according to a program stored in a read-only memory (ROM) 702 or a program loaded from a storage apparatus 708 into a random access memory (RAM) 703. The RAM 703 also stores various programs and data required for the operation of the electronic device 700. The processing apparatus 701, the ROM 702 and the RAM 703 are connected to each other through a bus 704. An input/output (I/O) interface 705 is also connected to the bus 704.

Generally, the following apparatus may be connected to the I/O interface 705: an input apparatus 706 including, for example, a touch screen, a touchpad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 may allow the electronic device to perform wireless or wired communication with other devices to exchange data. Although FIG. 7 shows an electronic device having various apparatuses, it should be understood that it is not required to implement or have all the illustrated apparatuses. Alternatively, more or fewer apparatuses may be implemented or provided.

In particular, according to the embodiments of the present disclosure, the processes described above with reference to the flowcharts can be implemented as computer software programs. For example, an embodiment of the present disclosure includes a computer program product, which includes a computer program carried on a non-transitory computer-readable medium, and the computer program includes program codes for executing the methods shown in the flowcharts. In such an embodiment, the computer program can be downloaded and installed from the network through the communication apparatus 709, or installed from the storage apparatus 708, or installed from the ROM 702. When the computer program is executed by the processing apparatus 701, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus or device. In the present disclosure, the computer-readable signal medium may include a data signal propagated in baseband or as part of a carrier wave, in which computer-readable program codes are carried. This propagated data signal can take a variety of forms, including but not limited to, an electromagnetic signal, an optical signal or any suitable combination thereof. The computer-readable signal medium may also be any computer-readable medium other than the computer-readable storage medium. The computer-readable signal medium can send, propagate or transmit the program used by or in combination with the instruction execution system, apparatus or device. The program codes contained on the computer-readable medium can be transmitted by any suitable medium, including but not limited to: wire, optical cable, RF (radio frequency), etc., or any suitable combination thereof.

In some implementations, the client and the server can communicate using any currently known or future developed network protocol such as HTTP (HyperText Transfer Protocol), and can be interconnected with any form or medium of digital data communication (for example, a communication network). Examples of the communication network include a local area network (“LAN”), a wide area network (“WAN”), an internet (for example, the Internet), and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs which, when executed by the electronic device, cause the electronic device to: display, in a tree view, a sub-item creation control for a first item, where the tree view presents a work item in a hierarchical structure, and the first item is a work item in the tree view; display a sub-item creation interface based on a first trigger operation on the sub-item creation control; create a second item based on input information in the sub-item creation interface, where the second item is a child work item of the first item; and display, in the tree view, second item information of the second item.

The computer program codes for performing the operations of the present disclosure can be written in one or more programming languages or a combination thereof, where the above programming languages include but are not limited to object-oriented programming languages such as Java, Smalltalk, C++, and also include conventional procedural programming languages such as “C” language or similar programming languages. The program codes can be executed entirely on a user's computer, partly on a user's computer, as a stand-alone software package, partly on a user's computer and partly on a remote computer, or entirely on a remote computer or server. In the case of the remote computer, the remote computer can be connected to the user's computer through any kind of network, including a local area network (LAN) or a wide area network (WAN), or can be connected to an external computer (for example, connected through the Internet using an Internet service provider).

The flowcharts and block diagrams in the drawings illustrate the architecture, functions and operations of possible implementations of systems, methods and computer program products according to various embodiments of the present disclosure. In this regard, each block in the flowcharts or block diagrams may represent a module, a program segment or a portion of codes, and the module, the program segment or the portion of codes contains one or more executable instructions for implementing specified logical functions. It should also be noted that, in some alternative implementations, the functions indicated in the blocks may be implemented in an order different from those indicated in the drawings. For example, two blocks shown in succession can, in fact, be executed substantially concurrently or in a reverse order, which depends on the functions involved. It should also be noted that, each block in the block diagrams and/or flowcharts and the combination of blocks in the block diagrams and/or flowcharts may be implemented by a dedicated hardware-based system that performs the specified functions or operations, or may be implemented by a combination of dedicated hardware and computer instructions.

The units involved in the embodiments described in the present disclosure may be implemented in software or hardware. The name of the unit does not constitute a limitation of the unit itself. For example, the checking unit may also be described as “a unit for determining whether the target value passes the check”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination of them. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of them.

The above description is only preferred embodiments of the present disclosure and an illustration of the applied technical principles. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosed concepts. For example, the technical solutions formed by replacing the above features with the technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments individually or in any suitable sub-combinations.

Although the subject matter has been described in language specific to structural features and/or logical actions of methods, it should be understood that the subject matter defined in the appended claims is not necessarily limited to the specific features or actions described above. On the contrary, the specific features and actions described above are only example forms for implementing the claims.

1. A method for project management, comprising:
displaying, in a tree view, a sub-item creation control for a first item, wherein the tree view presents a work item in a hierarchical structure, and the first item is a work item in the tree view;
displaying a sub-item creation interface based on a first trigger operation on the sub-item creation control;
creating a second item based on input information in the sub-item creation interface, wherein the second item is a child work item of the first item; and
displaying, in the tree view, second item information of the second item.

2. The method of claim 1, wherein the displaying a sub-item creation interface based on a first trigger operation on the sub-item creation control comprises:
determining a sub-item type based on an optional sub-item type of the first item in response to the first trigger operation on the sub-item creation control; and
displaying, in the sub-item creation interface, a preset field corresponding to the sub-item type according to the determined sub-item type, wherein corresponding information between a type and a field is stored in advance.

3. The method of claim 2, wherein the determining a sub-item type based on an optional sub-item type of the first item comprises:
displaying multiple optional sub-item types when a number of optional sub-item types of the first item is more than one, and determining the sub-item type according to a selection operation on the displayed optional sub-item types; and
determining the optional sub-item type of the first item as the sub-item type when a number of optional sub-item type of the first item is one.

4. The method of claim 1, further comprising:
pre-filling information of a part of fields in the sub-item creation interface according to first item information.

5. The method of claim 4, wherein the part of fields comprise at least one selected from the group consisting of: an associated work item field and a priority.

6. The method of claim 1, further comprising:
determining whether the first item has a child node based on the first trigger operation on the sub-item creation control;
displaying a candidate parent item in response to the first item having the child node, wherein the candidate parent item comprises at least one selected from the group consisting of: a child node of the first item and the first item; and
determining a parent item of the second item according to a selected candidate parent item, wherein the parent item of the second item is the child node of the first item or the first item.

7. The method of claim 1, wherein the displaying, in a tree view, a sub-item creation control for a first item comprises at least one selected from the group consisting of:
in the tree view, displaying the sub-item creation control for the first item by default in response to the first item already having a sub-item;
in the tree view, displaying the sub-item creation control for the first item based on a second trigger operation on the first item in response to the first item not having a sub-item and in response to the first item having an authority to add a sub-item;
in the tree view, displaying the sub-item creation control for the first item based on a second trigger operation on the first item; and
in the tree view, displaying the sub-item creation control for the first item by default.

8. The method of claim 2, wherein the displaying a sub-item creation interface based on a first trigger operation on the sub-item creation control comprises:
determining a sub-item creation interface in a corresponding display form according to a hierarchy corresponding to the sub-item type.

9. The method of claim 8, wherein the determining a sub-item creation interface in a corresponding display form according to a hierarchy corresponding to the sub-item type comprises at least one selected from the group consisting of:
displaying a first sub-item creation row in response to the hierarchy corresponding to the sub-item type being a lowest level, wherein the first sub-item creation row is a row in the tree view; and
displaying a sub-item creation details page in response to the hierarchy corresponding to the sub-item type not being the lowest level.

10. The method of claim 9, further comprising:
displaying a second sub-item creation row in response to a third trigger operation on the first sub-item creation row,
wherein the second sub-item creation row is used to create a third item, and the third item is a child work item of the first item.

11. An electronic device, comprising:
one or more processors; and
a storage apparatus configured to store one or more programs,
wherein the one or more programs, when executed by the one or more processors, cause the one or more processors to perform a method for project management, wherein the method comprises:
displaying, in a tree view, a sub-item creation control for a first item, wherein the tree view presents a work item in a hierarchical structure, and the first item is a work item in the tree view;
displaying a sub-item creation interface based on a first trigger operation on the sub-item creation control;
creating a second item based on input information in the sub-item creation interface, wherein the second item is a child work item of the first item; and
displaying, in the tree view, second item information of the second item.

12. The electronic device of claim 11, wherein the displaying a sub-item creation interface based on a first trigger operation on the sub-item creation control comprises:
determining a sub-item type based on an optional sub-item type of the first item in response to the first trigger operation on the sub-item creation control; and
displaying, in the sub-item creation interface, a preset field corresponding to the sub-item type according to the determined sub-item type, wherein corresponding information between a type and a field is stored in advance.

13. The electronic device of claim 12, wherein the determining a sub-item type based on an optional sub-item type of the first item comprises:
displaying multiple optional sub-item types when a number of optional sub-item types of the first item is more than one, and determining the sub-item type according to a selection operation on the displayed optional sub-item types; and
determining the optional sub-item type of the first item as the sub-item type when a number of optional sub-item type of the first item is one.

14. The electronic device of claim 11, wherein the method comprises:
pre-filling information of a part of fields in the sub-item creation interface according to first item information.

15. The electronic device of claim 14, wherein the part of fields comprise at least one selected from the group consisting of: an associated work item field and a priority.

16. The electronic device of claim 11, wherein the method comprises:
determining whether the first item has a child node based on the first trigger operation on the sub-item creation control;
displaying a candidate parent item in response to the first item having the child node, wherein the candidate parent item comprises at least one selected from the group consisting of: a child node of the first item and the first item; and
determining a parent item of the second item according to a selected candidate parent item, wherein the parent item of the second item is the child node of the first item or the first item.

17. The electronic device of claim 11, wherein the displaying, in a tree view, a sub-item creation control for a first item comprises at least one selected from the group consisting of:
in the tree view, displaying the sub-item creation control for the first item by default in response to the first item already having a sub-item;
in the tree view, displaying the sub-item creation control for the first item based on a second trigger operation on the first item in response to the first item not having a sub-item and in response to the first item having an authority to add a sub-item;
in the tree view, displaying the sub-item creation control for the first item based on a second trigger operation on the first item; and
in the tree view, displaying the sub-item creation control for the first item by default.

18. The electronic device of claim 12, wherein the displaying a sub-item creation interface based on a first trigger operation on the sub-item creation control comprises:
determining a sub-item creation interface in a corresponding display form according to a hierarchy corresponding to the sub-item type.

19. The electronic device of claim 18, wherein the determining a sub-item creation interface in a corresponding display form according to a hierarchy corresponding to the sub-item type comprises at least one selected from the group consisting of:
displaying a first sub-item creation row in response to the hierarchy corresponding to the sub-item type being a lowest level, wherein the first sub-item creation row is a row in the tree view; and
displaying a sub-item creation details page in response to the hierarchy corresponding to the sub-item type not being the lowest level.

20. A non-transitory computer-readable medium storing a computer program, wherein the program, when executed by a processor, performs a method for project management, wherein the method comprises:
displaying, in a tree view, a sub-item creation control for a first item, wherein the tree view presents a work item in a hierarchical structure, and the first item is a work item in the tree view;
displaying a sub-item creation interface based on a first trigger operation on the sub-item creation control;
creating a second item based on input information in the sub-item creation interface, wherein the second item is a child work item of the first item; and
displaying, in the tree view, second item information of the second item.
